(19) United States
(12) Patent Application Publication
(10) Pub. No.: US 2025/0200964 A1
(43) Pub. Date: Jun. 19, 2025

(54) INFORMATION PROCESSING APPARATUS, AUTHENTICATION SYSTEM, INFORMATION PROCESSING METHOD, NON-TRANSITORY COMPUTER-READABLE MEDIUM, LEARNED MODEL, AND METHOD FOR GENERATING LEARNED MODEL

(71) Applicant: NEC Corporation, Minato-ku, Tokyo (JP)

(72) Inventors: Misuzu SHINGAI, Tokyo (JP); Katsuya NAKASHIMA, Tokyo (JP); Honami SUZUKI, Tokyo (JP); Takeo TAMURA, Tokyo (JP); Masatoshi SUGISAWA, Tokyo (JP); Shinji KUBOTANI, Tokyo (JP)

(73) Assignee: NEC Corporation, Minato-ku, Tokyo (JP)

(21) Appl. No.: 18/851,806

(22) PCT Filed: May 9, 2023
(86) PCT No.: PCT/JP2023/017485

§ 371 Date: Sep. 27, 2024

(30) Foreign Application Priority Data
May 26, 2022 (JP) 2022-086397

(51) Int. Cl. G06V 10/98; G06F 21/32; G06V 40/20

(52) U.S. Cl. CPC G06V 10/993; G06F 21/32; G06V 40/23

(57) ABSTRACT

Provided is an information processing apparatus capable of estimating quality of biometric information according to a posture of a user. An information processing apparatus (100) according to the disclosure includes: a posture information acquisition unit (101) that acquires posture information indicating a posture of a user who performs biometric authentication; a learned model (102) learned to estimate quality information from input posture information and output estimated quality information by performing machine learning using the posture information and quality information indicating quality of biometric information corresponding to the posture information as teacher data; and an output unit (103) that outputs the estimated quality information from the acquired posture information using the learned model (102).

### TECHNICAL FIELD

The disclosure relates to an information processing apparatus, an information processing method, a program, a learned model, and a method for generating a learned model.

### BACKGROUND ART

A technique for performing authentication in consideration of variation in posture of a user when performing biometric authentication is known. As a related technology, Patent Literature 1 discloses a biometric authentication program for causing a computer to execute processing of authenticating a living body using an image obtained by imaging the living body. The program causes a computer to execute an imaging step of imaging an image of a living body, a display step of displaying an image of the living body captured in the imaging step on a screen, and a calculation step of processing the image of the living body captured in the imaging step. Furthermore, the program causes the computer to display, in the calculation step, a guidance image for guiding the position and posture of the living body when the living body is captured in the imaging step on the screen. Then, the program displays, as a guidance image, an arcuate trajectory image on the screen, the arcuate trajectory image prompting the user not to hold his or her fingertip on the screen along the arcuate trajectory.

Patent Literature 1 discloses a biometric authentication apparatus that causes a computer to execute such a program so that an imaging unit can image an image of each finger in a posture or a position suitable for authentication at the time of fingerprint authentication.

### CITATION LIST

### Patent Literature

Patent Literature 1: Japanese Unexamined Patent Application Publication No. 2020-003873

### SUMMARY OF INVENTION

### Technical Problem

When the fingerprint authentication is performed using the biometric authentication apparatus disclosed in Patent Literature 1, the user adjusts the position of his/her finger according to the displayed guidance image. However, even when the position of the finger is adjusted according to the guidance image, there is a problem that the imaging unit cannot obtain an image of a fingerprint suitable for authentication depending on the posture of the user.

In view of the above-described problems, an object of the disclosure is to provide an information processing apparatus, an information processing method, a program, a learned model, and a method for generating a learned model, capable of estimating quality of biometric information according to a posture of a user.

### Solution to Problem

An information processing apparatus according to the disclosure includes:
a posture information acquisition unit that acquires posture information indicating a posture of a user who performs biometric authentication;
a learned model learned to estimate quality information from the input posture information and output estimated quality information by performing machine learning using the posture information and quality information indicating quality of biometric information corresponding to the posture information as teacher data; and
an output unit that outputs the estimated quality information from the acquired posture information using the learned model.

An information processing method according to the disclosure causes a computer to execute:
a posture information acquisition step of acquiring posture information indicating a posture of a user who performs biometric authentication;
a step of inputting the acquired posture information to a learned model learned to estimate quality information from the input posture information and output estimated quality information by performing machine learning using the posture information and quality information indicating quality of biometric information corresponding to the posture information as teacher data;
a step of receiving the estimated quality information output from the learned model; and
an output step of outputting the received estimated quality information.

A program according to the disclosure causes a computer to execute:
a posture information acquisition step of acquiring posture information indicating a posture of a user who performs biometric authentication;
a step of inputting the acquired posture information to a learned model learned to estimate quality information from the input posture information and output estimated quality information by performing machine learning using the posture information and quality information indicating quality of biometric information corresponding to the posture information as teacher data;
a step of receiving the estimated quality information output from the learned model; and
an output step of outputting the received estimated quality information.

A learned model according to the disclosure includes:
an input layer that receives input of posture information indicating a posture of a user who performs biometric authentication; and
an output layer that estimates quality information indicating quality of biometric information corresponding to the posture information and outputs estimated quality information,
the learned model causing a computer to function to: input the posture information to the input layer and output the estimated quality information from the output layer.

A method for generating a learned model according to the disclosure causes a computer to execute:
an acquisition step of acquiring teacher data in which posture information indicating a posture of a user who performs biometric authentication is associated with a correct value of quality information indicating quality of biometric information corresponding to the posture information; and
a generation step of generating a learned model that estimates the quality information and outputs the estimated quality information when the posture information is input based on the acquired teacher data.

### BRIEF DESCRIPTION OF DRAWINGS

FIG. 1 is a block diagram illustrating a configuration of an information processing apparatus according to a first example embodiment.

FIG. 2 is a flowchart illustrating processing performed by the information processing apparatus according to the first example embodiment.

FIG. 3 is a block diagram illustrating an overall configuration of an authentication system according to a second example embodiment.

FIG. 4 is a block diagram illustrating a configuration of a posture information detection apparatus according to the second example embodiment.

FIG. 5 is a block diagram illustrating a configuration of a biometric information detection apparatus according to the second example embodiment.

FIG. 6 is a block diagram illustrating a configuration of an authentication apparatus according to the second example embodiment.

FIG. 7 is a diagram schematically illustrating processing performed by the information processing apparatus according to the second example embodiment.

FIG. 8 is a block diagram illustrating a configuration of an information processing apparatus according to the second example embodiment.

FIG. 9 is a flowchart illustrating estimation model generation processing according to the second example embodiment.

FIG. 10 is a diagram illustrating an example of an estimation model according to the second example embodiment.

FIG. 11 is a diagram schematically illustrating processing performed by a posture information modifying unit and a guidance information generation unit in the estimation step according to the second example embodiment.

FIG. 12 is a flowchart illustrating processing performed by the information processing apparatus in the estimation step according to the second example embodiment.

FIG. 13 is a block diagram illustrating a configuration of an information processing apparatus according to a third example embodiment.

FIG. 14 is a diagram schematically illustrating processing performed by the information processing apparatus according to the third example embodiment.

FIG. 15 is a flowchart illustrating processing performed by a quality information calculation unit according to the third example embodiment.

FIG. 16 is a block diagram illustrating a hardware configuration of a computer that implements an information processing apparatus and the like.

### EXAMPLE EMBODIMENT

Hereinafter, example embodiments of the disclosure will be described in detail with reference to the drawings. In the drawings, the same or corresponding elements are denoted by the same reference signs. For clarity of description, redundant description will be omitted as necessary.

### First Example Embodiment

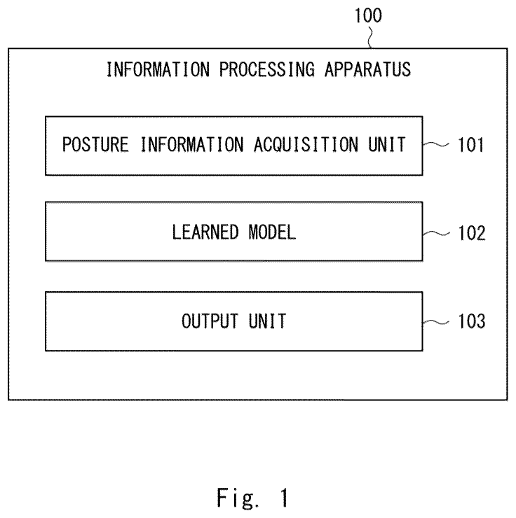

A first example embodiment will be described with reference to FIG. 1.

FIG. 1 is a block diagram illustrating a configuration of an information processing apparatus 100 according to the present example embodiment. The information processing apparatus 100 includes a posture information acquisition unit 101, a learned model 102, and an output unit 103.

The posture information acquisition unit 101 acquires posture information indicating the posture of the user who performs the biometric authentication. The learned model 102 is learned to estimate the quality information from the input posture information and output the estimated quality information by performing machine learning using the posture information and the quality information indicating the quality of the biometric information corresponding to the posture information as teacher data. The output unit 103 outputs the estimated quality information from the acquired posture information using the learned model 102.

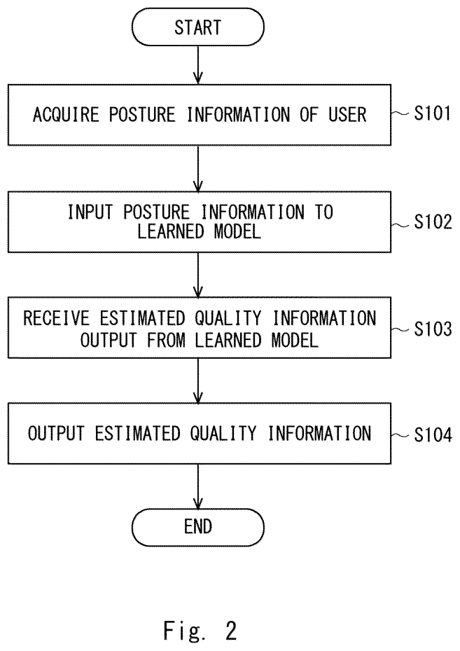

Next, processing performed by the information processing apparatus 100 according to the present example embodiment will be described with reference to FIG. 2. FIG. 2 is a flowchart illustrating processing performed by the information processing apparatus 100.

First, the posture information acquisition unit 101 acquires posture information indicating the posture of the user who performs the biometric authentication (S101). Next, the information processing apparatus 100 inputs the posture information acquired by the posture information acquisition unit 101 to the learned model 102 (S102). The information processing apparatus 100 receives the estimated quality information output from the learned model 102 (S103). The output unit 103 outputs the estimated quality information received from the learned model 102 (S104).

As described above, in the information processing apparatus 100 according to the present example embodiment, the learned model 102 is learned to estimate the quality information of the biometric information corresponding to the posture information from the input posture information and output the estimated quality information that is the estimation result. As a result, the information processing apparatus 100 can receive the estimated quality information output from the learned model 102 by inputting the posture information acquired by the posture information acquisition unit 101 to the learned model 102. The output unit 103 outputs the received estimated quality information. For example, the output unit 103 outputs the estimated quality information using a display, a speaker, or the like.

In this way, according to the information processing apparatus 100 according to the present example embodiment, it is possible to estimate the quality of the biometric information according to the posture of the user.

### Second Example Embodiment

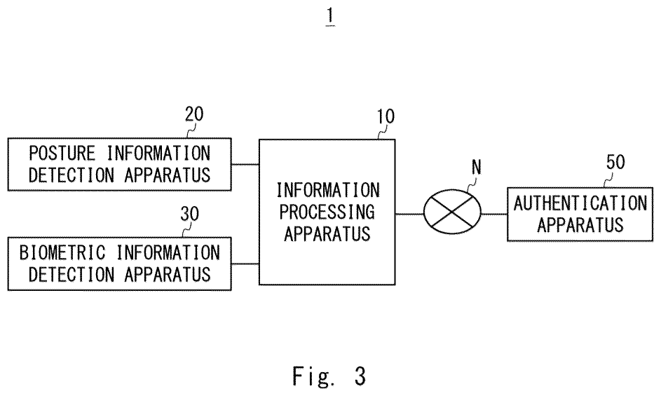

Next, a second example embodiment will be described. The second example embodiment is a specific example of the first example embodiment described above. FIG. 3 is a block diagram illustrating an overall configuration of the authentication system 1 according to the present example embodiment. A configuration of the authentication system 1 and an outline thereof will be described with reference to FIG. 3.

### (Configuration and Outline of Authentication System 1)

As illustrated in FIG. 3, the authentication system 1 includes an information processing apparatus 10, a posture information detection apparatus 20, a biometric information detection apparatus 30, and an authentication apparatus 50. The information processing apparatus 10 and the authentication apparatus 50 are connected via a network N. Here, the network N is a wired or wireless communication line. The configuration of the authentication system 1 is not limited to the illustrated configuration. For example, the posture information detection apparatus 20 and the biometric information detection apparatus 30 may be connected to the network N.

Furthermore, a plurality of information processing apparatuses 10, a plurality of posture information detection apparatuses 20, a plurality of biometric information detection apparatuses 30, and a plurality of authentication apparatuses 50 may be provided. For example, a plurality of information processing apparatuses 10 may be connected to one authentication apparatus 50. Furthermore, for example, a plurality of posture information detection apparatuses 20 and biometric information detection apparatuses 30 may be provided for one information processing apparatus 10.

The authentication system 1 is an information processing system for performing biometric authentication of a user by using biometric information obtained from the user who is a subject of the biometric authentication. The authentication system 1 is used, for example, in an airport, an ATM, a building, a station, a store, a hospital, a public facility, or the like, but is not limited thereto.

As an example of the biometric information, for example, a design (pattern) such as a face, a fingerprint, a voiceprint, a vein, a retina, or an iris can be used. The biometric information is not limited thereto, and various types of information with which it is possible to calculate a feature amount indicating a physical feature unique to the user may be used as the biometric information. The authentication system 1 performs biometric authentication of the user using such biometric information. The authentication system 1 may perform biometric authentication using a plurality of pieces of biometric information.

In the authentication system 1, the biometric information detection apparatus 30 acquires the biometric information as described above from the user and outputs the biometric information to the information processing apparatus 10. Furthermore, the posture information detection apparatus 20 acquires posture information indicating the posture of the user when the biometric information is acquired, and outputs the posture information to the information processing apparatus 10. As described later, the posture information can include, for example, joint position information indicating a joint position of the user, vibration information indicating vibration of the user, body shape information indicating a body shape of the user, or the like.

The information processing apparatus 10 stores an estimation model (learned model) generated by performing predetermined learning. The estimation model is learned to estimate the quality information from the input posture information and output the estimated quality information by performing machine learning using the above-described posture information and the quality information indicating the quality of the biometric information corresponding to the posture information as teacher data.

Here, the quality of the biometric information indicates whether the biometric information is in a state suitable for biometric authentication. For example, the higher the quality of the biometric information, the more suitable the biometric information is for the biometric authentication, and the lower the quality of the biometric information, the less suitable the biometric information is for the biometric authentication. The quality information can be set to be higher as the posture of the user at the time of reading the biometric information is correct. Furthermore, the quality of the biometric information can be set lower as the posture of the user deviates from the correct posture.

In a case where the biometric information is estimated to have a predetermined quality level or higher, the authentication apparatus 50 performs biometric authentication using the biometric information. For example, it is assumed that a fingerprint image including a fingerprint pattern of the user is used as the biometric information. When the quality of the fingerprint image is estimated to be equal to or higher than a predetermined value, the authentication apparatus 50 determines that the fingerprint image has sufficient quality to be used for fingerprint matching, and performs fingerprint authentication.

The information processing apparatus 10 outputs the estimated quality information estimated from the posture information acquired by the posture information detection apparatus 20 using the learned model. Furthermore, the information processing apparatus 10 can also generate and output guidance information for prompting a change in the posture of the user according to the estimated quality information. The user changes his/her own posture according to the output estimated quality information or guidance information. The biometric information detection apparatus 30 detects the biometric information again in the changed posture.

As a result, the information processing apparatus 10 can acquire a fingerprint image of appropriate quality. The information processing apparatus 10 transmits the fingerprint image to the authentication apparatus 50 to make an authentication request, and acquires an authentication result from the authentication apparatus 50.

With such a configuration, in the authentication system 1, the information processing apparatus 10 estimates the quality of the biometric information based on the posture information of the user who performs the biometric authentication. In addition, the authentication system 1 can prompt the user to change the posture by outputting the estimated quality information and the guidance information according to the estimated quality information. Therefore, according to the authentication system 1, biometric authentication can be appropriately performed.

Next, each configuration of the authentication system 1 will be specifically described. Hereinafter, as an example of the biometric information used in the authentication system 1, a fingerprint of the user will be described. In addition, as an example of a place where the authentication system 1 is used, a predetermined gate apparatus that performs an immigration inspection at an airport will be described as an example. Therefore, the user can perform fingerprint authentication in the authentication system 1 provided in the gate apparatus, and pass the immigration inspection according to the success of the authentication.

(Posture information detection apparatus 20)

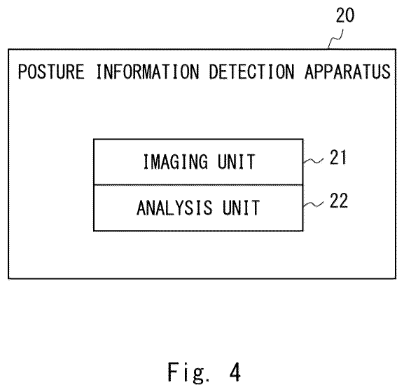

First, the posture information detection apparatus 20 will be described with reference to FIG. 4. FIG. 4 is a block diagram illustrating a configuration of the posture information detection apparatus 20. The posture information detection apparatus 20 detects posture information indicating the posture of the user who performs the biometric authentication.

Here, the posture information will be described. The posture information is information indicating a posture taken by the user when the biometric information detection apparatus 30 acquires the biometric information of the user.

The posture information may indicate the posture of the entire body of the user, or may indicate the posture of a specific body part. The specific body part may or may not be a part where biometric information used for biometric authentication is detected.

For example, posture information of the user who performs fingerprint authentication may indicate a posture of a hand or a posture of a finger of the user, or may indicate a posture of a body part other than the finger. Furthermore, the posture information may indicate the posture of the entire body of the user. In a case where the posture information indicates the posture of the entire body of the user, the posture information may include the posture information of the fingers or may not include the posture information of the fingers. A specific example of the posture information will be described later.

As illustrated in FIG. 4, the posture information detection apparatus 20 includes an imaging unit 21 and an analysis unit 22. The imaging unit 21 is an imaging device that images a user who is a subject of biometric authentication. The imaging unit 21 is, for example, a camera. The imaging unit 21 images the user from a predetermined position and acquires a captured image. The captured image may be a still image or a moving image.

Furthermore, the imaging unit 21 can be configured to be able to image the user from a plurality of imaging positions. For example, the posture information detection apparatus 20 includes a plurality of imaging units 21, so that each imaging unit 21 images the user. Alternatively, the posture information detection apparatus 20 may be configured such that the position of the imaging unit 21 can be changed by a driving unit (not illustrated). As a result, the imaging unit 21 can change the imaging range according to the height of the user and whether the wheelchair is used.

The analysis unit 22 analyzes the captured image acquired by the imaging unit 21 and detects posture information. The analysis unit 22 outputs the detected posture information to the information processing apparatus 10.

### (Specific Example of Posture Information)

Here, the function of the analysis unit 22 will be described using a specific example of the posture information. Hereinafter, joint position information, vibration information, and body shape information of the user will be described as examples of the posture information.

A specific example of the first posture information is joint position information indicating the joint position of the user. The analysis unit 22 estimates the joint position of the user based on the captured image acquired by the imaging unit 21, and acquires the estimation result as joint position information.

For example, the analysis unit 22 detects the user who is a subject from the captured image and estimates the joint position of the user using a known method. The joint position may be, for example, a position such as a top of head, a neck, a shoulder, an elbow, a wrist, a waist, a knee, or an ankle. The analysis unit 22 may specify a body part related to the biometric information and estimate a joint position of the specified body part. For example, in the case of the fingerprint authentication, the analysis unit 22 may specify a shoulder, an elbow, and a wrist related to the fingerprint authentication and estimate joint positions thereof.

Since the joint positions described above are an example, the analysis unit 22 may estimate some of them or may estimate the joint positions of other body parts. Furthermore, the analysis unit 22 may analyze the captured image using not only the joint positions but also information such as axes connecting the joints and acquire the analysis result as the joint position information.

The analysis unit 22 may estimate the posture of the user based on the acquired joint position information using a predetermined determination condition. For example, the analysis unit 22 may estimate the posture of the user such as “the back of the user is curled,” “the wrist of the user is bent,” or “the face is not facing forward,” and include the estimation result in the posture information.

The second example of the posture information is vibration information indicating vibration of the user. The analysis unit 22 estimates vibration occurring in the user based on the captured image acquired by the imaging unit 21, and acquires an estimation result as vibration information. For example, the analysis unit 22 detects the vibration of the user using a known method based on the captured image. The analysis unit 22 detects vibration of the entire body or body part of the user and estimates the frequency and amplitude of the vibration. The analysis unit 22 acquires the estimated frequency and the like as vibration information in association with the body part. The analysis unit 22 may acquire vibration information of a body part related to the biometric information. For example, in the case of fingerprint authentication, the analysis unit 22 acquires vibration information indicating vibration of the user's hand.

A third example of the posture information is body shape information indicating the body shape of the user. The analysis unit 22 estimates a body shape of the user based on the captured image acquired by the imaging unit 21, and acquires an estimation result as body shape information. For example, the analysis unit 22 detects the body shape of the user using a known method based on the captured image. The body shape information may include, for example, information regarding the height and the physique of the user. Furthermore, the body shape information may include, for example, information such as “the user uses a wheelchair.”

The above-described posture information can be represented by a parameter value corresponding to a parameter for representing the posture of the user. Note that, since the above-described posture information is an example, the analysis unit 22 may detect other information as the posture information based on the captured image. Furthermore, although an example of detecting posture information from a captured image is used here, the analysis unit 22 may detect posture information from other information according to the type of biometric information or the like.

Note that, here, the posture information detection apparatus 20 analyzes the captured image and outputs the posture information to the information processing apparatus 10, but the present disclosure is not limited thereto. For example, the posture information detection apparatus 20 may image the user, the captured image may be used as the information processing apparatus 10, and the image may be analyzed in the information processing apparatus 10. The same applies to the biometric information detection apparatus 30 described later.

### (Biometric Information Detection Apparatus 30)

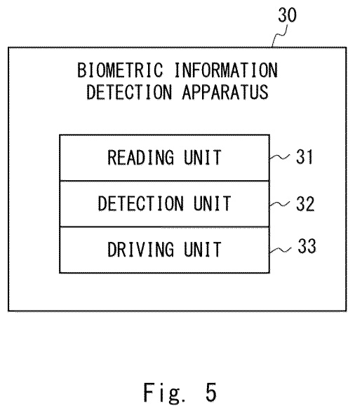

Next, a configuration of the biometric information detection apparatus 30 will be described with reference to FIG. 5. FIG. 5 is a block diagram illustrating a configuration of the biometric information detection apparatus 30. The biometric information detection apparatus 30 is an apparatus that detects biometric information of a user used for biometric authentication. In the present example embodiment, the biometric information detection apparatus 30 detects fingerprint information of the user. As illustrated in FIG. 5, the biometric information detection apparatus 30 includes a reading unit 31, a detection unit 32, and a driving unit 33.

The reading unit 31 reads biometric information of the user. The reading unit 31 is, for example, a scanner apparatus or a sensor that reads a fingerprint of a user. In the present example embodiment, the reading unit 31 will be described as having a reading surface on which a user's finger is placed. The reading unit 31 reads a fingerprint of a finger placed on a reading surface. The reading unit 31 converts the fingerprint image of the user obtained by the reading into digital data and outputs the digital data to the detection unit 32.

Furthermore, the reading unit 31 may be configured to be movable according to the driving of the driving unit 33. For example, the reading unit 31 can be configured to be movable in the vertical direction, the horizontal direction, or both. For example, since the height of the reading surface can be changed by moving the reading unit 31 in the vertical direction, the user can read the fingerprint at a position suitable for his/her height or the like.

Furthermore, the biometric information detection apparatus 30 may include a plurality of reading units 31, and operate different reading units 31 according to the situation of the user or the like. For example, it is assumed that the biometric information detection apparatus 30 includes two reading units 31 having different heights. The biometric information detection apparatus 30 may read the fingerprint of the user by the reading unit 31 at a low or high position according to the height of the user, whether the user uses the wheelchair, and the like. Furthermore, the reading unit 31 may be configured to be able to change the angle of the reading surface.

The detection unit 32 detects the biometric information based on the information acquired by reading unit 31. In the present example embodiment, the detection unit 32 detects the fingerprint information of the user based on the fingerprint image acquired by the reading unit 31. For example, the detection unit 32 calculates the feature amount of the fingerprint of the user using a known method, and detects the calculation result as fingerprint information.

The driving unit 33 moves the reading unit 31 under the control of a drive control unit 16 of the information processing apparatus 10 described later. The driving unit 33 can be configured by, for example, a motor for moving the reading unit 31.

### (Authentication Apparatus 50)

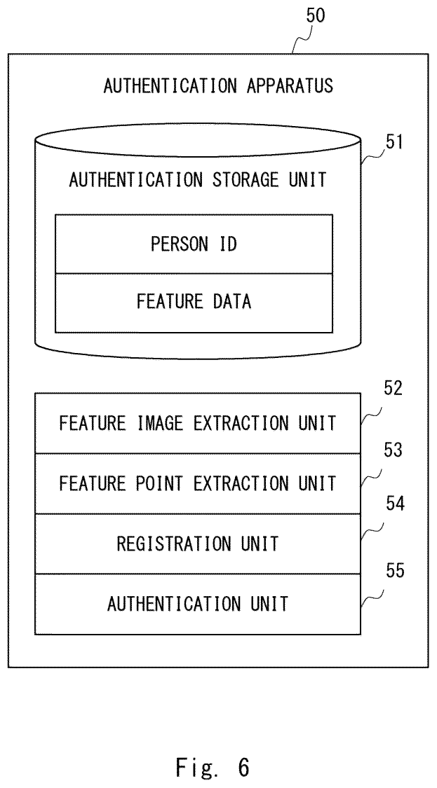

Next, a configuration of the authentication apparatus 50 will be described with reference to FIG. 6. FIG. 6 is a block diagram illustrating a configuration of the authentication apparatus 50. The authentication apparatus 50 is a computer that performs biometric authentication of the user. The authentication apparatus 50 receives an image related to the biometric information of the user from the information processing apparatus 10, and extracts a predetermined feature image from the received image to authenticate the person. The feature image is, for example, a fingerprint pattern image.

The authentication apparatus 50 mainly includes an authentication storage unit 51, a feature image extraction unit 52, a feature point extraction unit 53, a registration unit 54, and an authentication unit 55.

The authentication storage unit 51 stores a person ID related to a person registered in advance and feature data of the person in association with each other. The feature image extraction unit 52 detects a feature region included in an image relating to biometric information of the user and outputs the feature region to the feature point extraction unit 53. The feature point extraction unit 53 extracts a feature point from the feature region detected by the feature image extraction unit 52, and outputs data regarding the feature point to the registration unit 54. The data relating to feature points is a set of extracted feature points.

The registration unit 54 newly issues a person ID when registering the feature data. The registration unit 54 registers the issued person ID and the feature data extracted from the registered image in the authentication storage unit 51 in association with each other. The authentication unit 55 collates the feature data extracted from the image relating to the biometric information of the user with the feature data in the authentication storage unit 51. In a case where there is feature data that matches the biometric information of the user, the authentication unit 55 determines that the authentication has succeeded. On the other hand, when there is no feature data that matches the biometric information of the user, the authentication unit 55 determines that the authentication has failed. The authentication unit 55 supplies information regarding success or failure of authentication to the information processing apparatus 10. In addition, in a case where the authentication is successful, the authentication unit 55 specifies a person ID associated with the successful feature data and notifies the information processing apparatus 10 of an authentication result including the specified person ID.

### (Outline of Information Processing Apparatus 10)

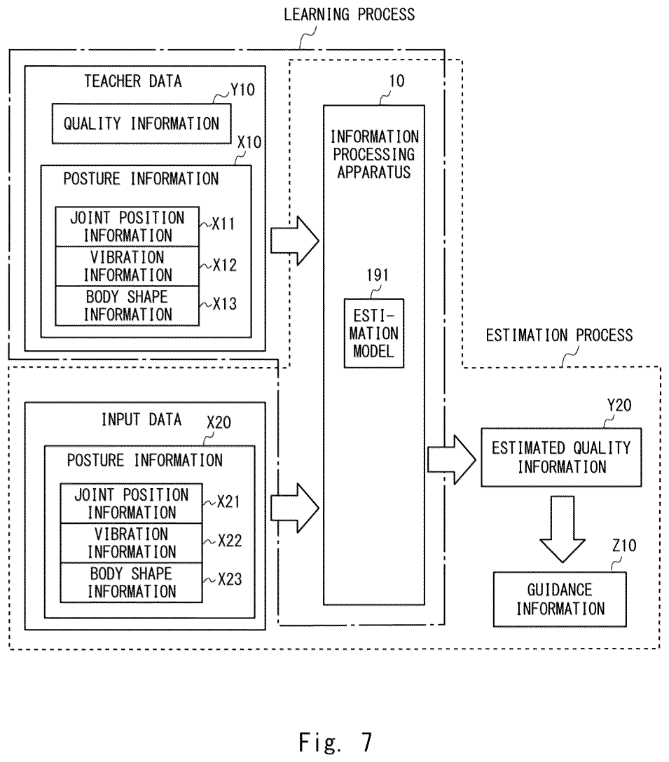

Next, the information processing apparatus 10 will be described with reference to FIGS. 7 to 12. The information processing apparatus 10 is a computer for performing information processing according to the present example embodiment. The information processing apparatus 10 is, for example, a personal computer (PC) or a tablet terminal. The present disclosure is not limited thereto, and various apparatuses may be used as the information processing apparatus 10.

First, an outline of processing performed by the information processing apparatus 10 in the authentication system 1 will be described with reference to FIG. 7. FIG. 7 is a diagram schematically illustrating processing performed by the information processing apparatus 10. As illustrated in the figure, the processing performed by the information processing apparatus 10 can be indicated by a learning process and an estimation process.

In the learning step, the information processing apparatus 10 performs predetermined learning using the teacher data and generates the estimation model 191. The teacher data is, for example, posture information X10 and quality information Y10 corresponding to the posture information X10. The posture information X10 may include some or all of the joint position information X11, the vibration information X12, and the body shape information X13.

Note that, here, an example will be described in which the estimation model 191 is generated in the learning unit 11 of the information processing apparatus 10, but the estimation model 191 may be generated in advance by another apparatus. Details of the generation of the estimation model 191 will be described later.

Furthermore, in the estimation step, the information processing apparatus 10 outputs the estimated quality information Y20 from the input data using the estimation model 191 generated in the learning step. The input data is, for example, posture information X20. The posture information X20 may include some or all of the joint position information X21, the vibration information X22, and the body shape information X23.

The information processing apparatus 10 inputs the posture information X20 to the estimation model 191, and receives the estimated quality information Y20 as an output from the estimation model 191. For example, the information processing apparatus 10 outputs the estimated quality information Y20 to a display or the like. By visually recognizing the estimated quality information

Y20, the user can grasp whether the quality of the fingerprint image corresponding to the user's own posture is estimated to be sufficient for performing fingerprint authentication.

Furthermore, the information processing apparatus 10 generates guidance information Z10 for prompting the user to change the posture according to the estimated quality information Y20. In the drawing, the generation of the guidance information Z10 is included in the estimation step, but may be provided as another step. Details of the generation of the guidance information Z10 will be described later.

The information processing apparatus 10 outputs the generated guidance information Z10 to a display or the like. Thereby, the user can change his/her posture to improve the quality of the fingerprint image.

Furthermore, although not illustrated in FIG. 7, the information processing apparatus 10 performs fingerprint authentication using the authentication apparatus 50 in a case where it is estimated that the quality of the fingerprint image corresponding to the posture of the user is equal to or higher than a predetermined value. The information processing apparatus 10 receives a fingerprint authentication result from the authentication apparatus 50. When the fingerprint authentication is successful, information processing apparatus 10 transmits a cancellation instruction to a predetermined gate apparatus. This allows the user to pass through the gate. The information processing apparatus 10 may output the authentication result to a display or the like.

### (Configuration of Information Processing Apparatus 10)

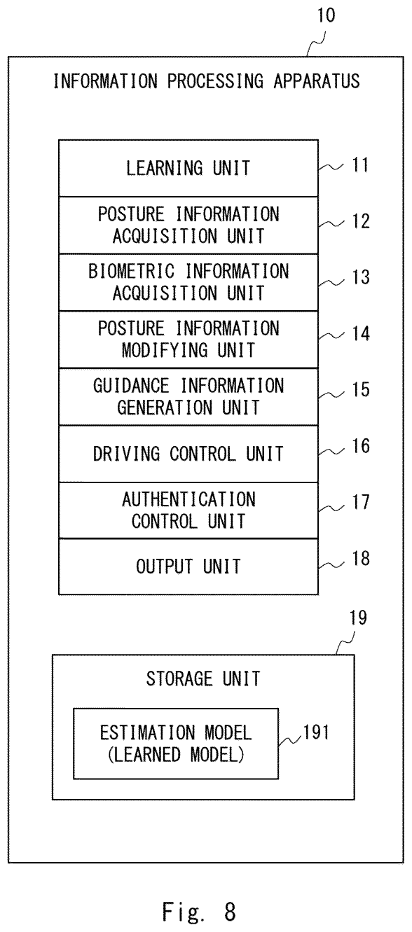

Next, a configuration of the information processing apparatus 10 will be described in detail with reference to FIG. 8. FIG. 8 is a block diagram illustrating a configuration of the information processing apparatus 10. Furthermore, a description will be given with appropriate reference to FIG. 7 described above.

As illustrated in FIG. 8, the information processing apparatus 10 includes a learning unit 11, a posture information acquisition unit 12, a biometric information acquisition unit 13, a posture information modifying unit 14, a guidance information generation unit 15, a drive control unit 16, an authentication control unit 17, an output unit 18, and a storage unit 19.

The learning unit 11 generates the estimation model 191 by performing machine learning using the posture information X10 and the quality information Y10 indicating the quality of the biometric information corresponding to the posture information X10 as teacher data. The estimation model 191 is an example of the learned model 102 described above.

### (Estimation Model Generation Processing)

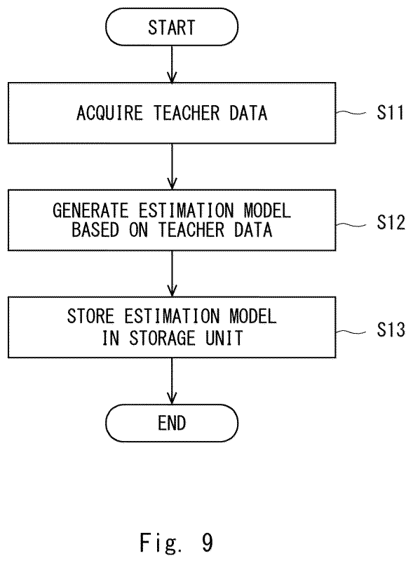

Here, estimation model generation processing for the learning unit 11 to generate the estimation model 191 will be described with reference to FIG. 9. FIG. 9 is a flowchart illustrating estimation model generation processing.

First, the learning unit 11 acquires teacher data (S11). The teacher data is obtained by associating posture information indicating the posture of the user who performs the biometric authentication with a correct value of quality information indicating the quality of the biometric information corresponding to the posture information. As illustrated in FIG. 7, in the present example embodiment, the teacher data is posture information X10 and quality information Y10.

In FIG. 7, posture information X10 includes all of joint position information X11, vibration information X12, and body shape information X13, but is not limited thereto. The posture information X10 may include a part of the joint position information X11, the vibration information X12, and the body shape information X13. For example, only one of the joint position information X11, the posture information acquisition unit 12, and the biometric information acquisition unit 13 may be used as the posture information X10, or two or more thereof may be used. Furthermore, the posture information X10 may include other information. The other information may include, for example, the age of the user.

In the present example embodiment, since the fingerprint information is used as the biometric information, the quality information Y10 is information indicating the quality of the fingerprint image corresponding to the posture information X10. The quality information Y10 is indicated by, for example, a quality value indicating the quality of the fingerprint image. The quality value may be calculated by analyzing the fingerprint image according to a predetermined algorithm. Alternatively, the quality information Y10 may be calculated by a person viewing the fingerprint image. The present disclosure is not limited thereto, and the quality value can be calculated by an arbitrary method.

Next, the learning unit 11 generates the estimation model 191 based on the acquired teacher data (S12). When posture information X10 obtained from the user who performs the fingerprint authentication is input, the learning unit 11 causes the estimation model 191 to estimate the quality information of the fingerprint information corresponding to the posture information X10 and output quality information Y10 as the estimated quality information. Then, the learning unit 11 stores the generated estimation model 191 in the storage unit 19 (S13).

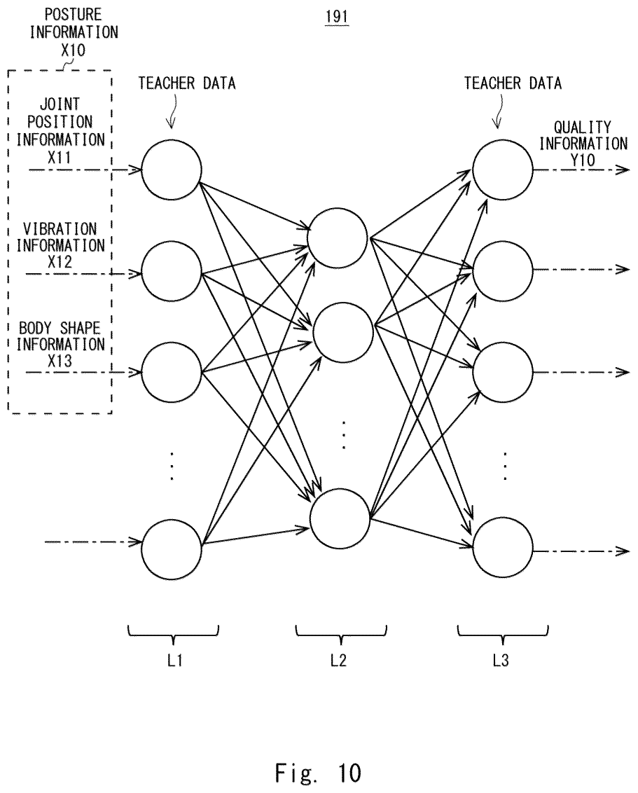

FIG. 10 is a diagram illustrating an example of the estimation model 191. The estimation model 191 is, for example, a neural network that receives the posture information of the user as an input, estimates the quality information of the biometric information corresponding to the posture information, and outputs the estimated quality information. The neural network may be, for example, a convolution neural network (CNN) or the like.

As illustrated in FIG. 10, the estimation model 191 has a multilayer structure including, for example, an input layer L1, an intermediate layer L2, and an output layer L3. In FIG. 10, nerve cell elements included in each layer are indicated by circles, and transmission elements connecting the layers are indicated by solid arrows. The transmission element has a weighting value in order to transmit the state of the neuronal element from the input layer L1 towards the output layer L3. Note that information input to the input layer L1 and information output from the output layer L3 are indicated by alternate long and short dash lines.

As illustrated in the figure, the input layer L1 includes a nerve cell element that receives input of posture information X10 indicating the posture of the user. In addition, the intermediate layer L2 has nerve cell elements to which the output from the input layer L1 is input, and each nerve cell element is coupled to the nerve cell element of the input layer L1 via a transmission element.

The intermediate layer L2 performs machine learning of a parameter used for arithmetic processing of extracting a feature amount of posture information from posture information based on posture information X10 and quality information Y10 which are teacher data. A known algorithm may be used for machine learning.

The output layer L3 has nerve cell elements to which the output from the intermediate layer L2 is input, and each nerve cell element is coupled to the nerve cell element of the intermediate layer L2 via a transmission element. The output layer L3 estimates the quality information of the biometric information input to the input layer L1 based on the calculation result in the intermediate layer L2, and outputs the estimated quality information.

When the unknown posture information X20 is input, the estimation model 191 outputs estimated quality information Y20 estimated from the posture information X20. The learning unit 11 uses the difference between the quality information Y10 and the estimated quality information Y20 as an error, inputs the error to the estimation model 191, and performs learning so as to reduce the error. Before performing learning, the learning unit 11 generates the estimated quality information Y20 having a large error with respect to the input of the posture information X20. The learning unit 11 constructs the estimation model 191 so as to minimize the error.

In this way, the estimation model 191 can cause the computer to function so as to input the posture information of the user to the input layer L1 and output the estimated quality information from the output layer L3. Note that, since the example illustrated in FIG. 10 is an example, the configuration of the estimation model 191 is not limited to the illustrated configuration. For example, the intermediate layer L2 may have a multilayer structure.

Returning to FIG. 8, the description will be continued. The posture information acquisition unit 12 is an example of the posture information acquisition unit 101 described above. In the learning process and the estimation process, the posture information acquisition unit 12 acquires the posture information X10 and the posture information X20 of the user from the posture information detection apparatus 20.

The biometric information acquisition unit 13 acquires the biometric information of the user from the biometric information detection apparatus 30. In the present example embodiment, the biometric information acquisition unit 13 acquires fingerprint information as biometric information.

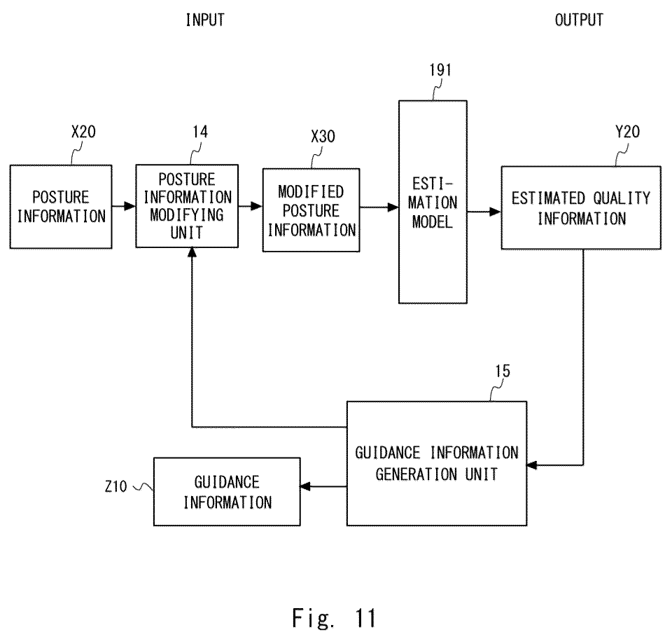

Subsequently, the posture information modifying unit 14 and the guidance information generation unit 15 will be described with reference to FIG. 11 together with FIG. 8. FIG. 11 is a diagram schematically illustrating processing performed by the posture information modifying unit 14 and the guidance information generation unit 15 in the estimation step.

When the estimated quality information Y20 estimated from the posture information X20 is less than the predetermined quality level, the posture information modifying unit 14 generates the modified posture information X30 using the posture information X20 as illustrated in FIG. 11. Specifically, the posture information modifying unit 14 generates modified posture information X20 obtained by modifying the posture information X20 by changing the parameter value of the posture information X30. The parameter value may indicate, for example, a value of a parameter included in the joint position information X21, the vibration information X22, or the body shape information X23 included in the posture information X20. The parameter value may be, for example, coordinates indicating a joint position of a body part, an angle of a joint, or the like.

As a result, the posture information modifying unit 14 can obtain the modified posture information X30 indicating a posture slightly different from the posture based on the posture actually taken by the user. The modified posture information X30 is used for generating the guidance information Z10 in the guidance information generation unit 15.

The posture information modifying unit 14 may generate the modified posture information X20 by changing a plurality of parameter values included in the posture information X30. Furthermore, the posture information modifying unit 14 may appropriately determine a parameter to be changed and a change amount thereof. The posture information modifying unit 14 can generate the modified posture information X30 indicating the modified posture close to the user's posture by setting the amount of change in the parameter value to be small.

Furthermore, the posture information modifying unit 14 may determine the parameter and the change amount according to the level of quality indicated by the estimated quality information Y20. For example, the posture information modifying unit 14 may reduce the change amount of the parameter value as the quality indicated by the estimated quality information Y20 is higher. The posture information modifying unit 14 may generate the modified posture information X30 using a predetermined algorithm or the like.

The guidance information generation unit 15 generates guidance information Z10 for prompting the user to change the posture according to the estimated quality information Y20 estimated from the estimation model 191. The guidance information Z10 prompts the user to change the posture so as to improve the quality of the fingerprint image obtained from the user. Specifically, as illustrated in FIG. 11, the guidance information generation unit 15 inputs the modified posture information X30 generated by the posture information modifying unit 14 to the estimation model 191, and generates the guidance information Z10 according to the estimated quality information Y20 output from the estimation model 191.

The guidance information Z10 may be information prompting a change in the posture of the user by characters, images, sounds, vibrations, or the like. The guidance information generation unit 15 generates, for example, information for outputting a message such as “Please stretch your elbows a little more.” by text or voice as the guidance information Z10. Note that the guidance information Z10 may be for users other than the user who is the target of fingerprint authentication. For example, the guidance information Z10 may be for an administrator of the authentication system 1, a person in charge of performing a fingerprint authentication procedure, or the like. In this case, the administrator or the like can prompt the user to change the posture orally or the like according to the guidance information Z10.

Note that the guidance information Z10 may include various types of information regarding the posture change of the user. For example, the guidance information Z10 may include information for notifying the user of changing the reading of the biometric information from the non-contact method to the contact method, encouraging the user to use a handrail or a chair in order to stabilize the posture, or changing the position of the reading unit 31.

Note that the guidance information generation unit 15 may simply generate guidance information Z10 for notifying the user or the like of the quality indicated by the estimated quality information Y20. For example, the guidance information generation unit 15 may determine whether the quality of the fingerprint image is sufficient for performing fingerprint authentication, and generate the guidance information Z10 for notifying the determination result. For example, when determining that the quality of the fingerprint image is sufficient, the guidance information generation unit 15 generates guidance information Z10 for displaying a message such as “Fingerprint reading is completed.” When determining that the quality of the fingerprint image is not sufficient, the guidance information generation unit 15 generates guidance information Z10 for displaying a message such as “In that posture, the quality of the fingerprint image may not be sufficient.” In this way, when the quality of the fingerprint image is not sufficient, the user can change the posture and attempt fingerprint authentication.

The guidance information generation unit 15 outputs the generated guidance information Z10 to the output unit 18 to cause the output unit 18 to output the guidance information Z10.

Returning to FIG. 8, the description will be continued. The drive control unit 16 controls the driving unit 33 of the biometric information detection apparatus 30 according to the estimated quality information Y20. For example, when the estimated quality information Y20 is less than the predetermined quality level, the drive control unit 16 controls the driving unit 33 according to the posture information X20.

For example, it is assumed that the vibration information X22 indicates that the vibration of the user's hand is equal to or higher than a predetermined value. The drive control unit 16 controls the driving unit 33 according to the height of the user or the like so as to move the reading unit 31 to a position where vibration of the user's hand becomes small. For example, in a case where the position of reading unit 31 is higher than the standing height of the user, the drive control unit 16 controls the driving unit 33 to lower the position of the reading unit 31. The present disclosure is not limited thereto, and the drive control unit 16 may control an operation such as raising the position of the reading unit 31, moving the reading unit to the left and right, or changing the angle of the reading surface.

The authentication control unit 17 determines whether the estimated quality information Y20 is a predetermined quality level or higher, and controls the biometric authentication according to the determination result. When the estimated quality information Y20 indicates a predetermined quality level or higher, the authentication control unit 17 transmits a biometric authentication request including the biometric information to the authentication apparatus 50. The authentication control unit 17 receives the result of the biometric authentication from the authentication apparatus 50.

The output unit 18 is an example of the output unit 103 described above. The output unit 18 outputs the estimated quality information Y20 from the acquired posture information X20 using the estimation model 191. In addition, the output unit 18 outputs the guidance information Z10 generated according to the estimated quality information Y20. The output unit 18 is an output apparatus for outputting the estimated quality information Y20 and the guidance information Z10. The output unit 18 may be, for example, a display, a speaker, a lamp, a vibrator, or the like. The output unit 18 may be configured to include, for example, a display for a user and a display for an administrator.

Since the output unit 18 outputs the estimated quality information Y20, the user who is the target of the biometric authentication, the administrator of the authentication system 1, the person in charge of performing the fingerprint authentication procedure, or the like can grasp whether the posture of the user at the time of the biometric authentication is appropriate. Therefore, in a case where the posture is not appropriate, the user can change the posture and read the biometric information again.

Furthermore, the output unit 18 outputs the guidance information Z10, so that the user or the like can grasp what kind of posture the more appropriate posture is. As a result, the user can change his/her posture to a posture in which the quality of the biometric information is estimated to be sufficient.

The storage unit 19 is a storage device that stores a program for realizing each function of the information processing apparatus 10. In addition, the storage unit 19 stores the estimation model 191 described above.

### (Processing of Information Processing Apparatus 10)

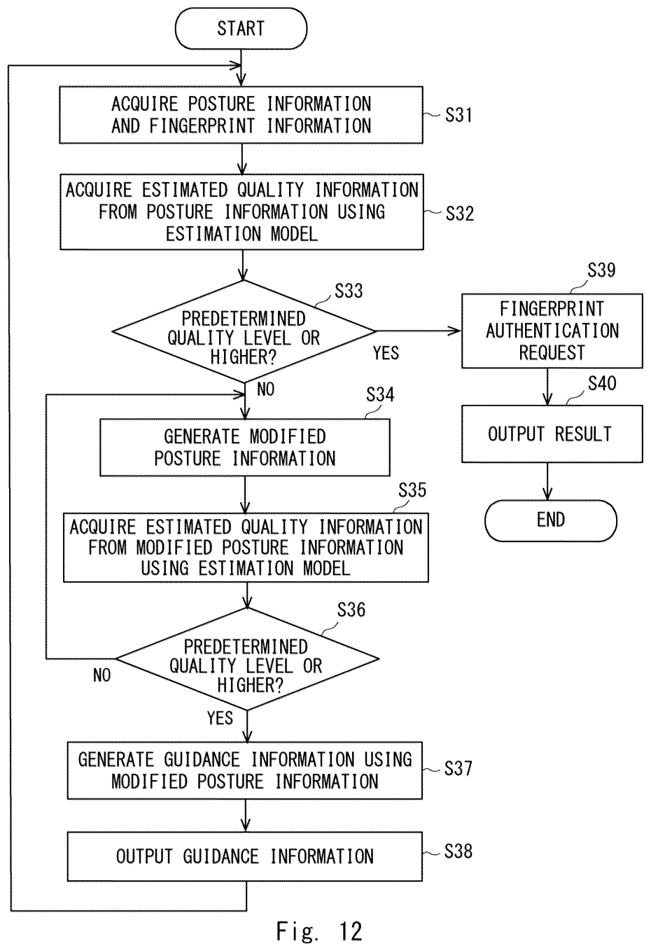

Subsequently, processing performed by the information processing apparatus 10 in the estimation step will be described with reference to FIG. 12.

FIG. 12 is a flowchart illustrating processing performed by the information processing apparatus 10 in the estimation step.

Hereinafter, it is assumed that the learning of the estimation model 191 has already been completed and the estimation model 191 has been stored in the storage unit 19. In addition, it is assumed that the user reads the fingerprint using the biometric information detection apparatus 30, and the posture information detection apparatus 20 acquires posture information X20 of the user at that time.

First, the posture information acquisition unit 12 acquires posture information X20 and fingerprint information of the user from the posture information detection apparatus 20 and the biometric information detection apparatus 30, respectively (S31). The fingerprint information is a fingerprint image including a fingerprint pattern of the user. The authentication control unit 17 acquires the estimated quality information Y20 from the posture information X20 using the estimation model 191 (S32). Specifically, the authentication control unit 17 inputs the posture information X20 to the estimation model 191, and receives the estimated quality information Y20 as an output.

The authentication control unit 17 determines whether the estimated quality information Y20 indicates a predetermined quality level or higher (S33). When the estimated quality information Y20 is the predetermined quality level or higher (YES in S33), the authentication control unit 17 transmits a fingerprint image to the authentication apparatus 50 and makes a fingerprint authentication request (S39). The authentication control unit 17 receives a fingerprint authentication result from the authentication apparatus 50. The output unit 18 outputs the fingerprint authentication result (S40), and ends the processing.

When the estimated quality information Y20 is less than the predetermined quality level (NO in S33), the posture information modifying unit 14 changes the parameter value of the posture information X20 and generates modified posture information X20 having a parameter value different from that of the posture information X30 (S34).

The guidance information generation unit 15 acquires the estimated quality information Y20 from the modified posture information X30 using the estimation model 191 (S35). Specifically, the guidance information generation unit 15 inputs the posture information X20 to the estimation model 191, and receives the estimated quality information Y20 as an output.

The guidance information generation unit 15 determines whether the estimated quality information Y20 indicates a predetermined quality level or higher (S36). When the estimated quality information Y20 is the predetermined quality level or higher (YES in S36), the guidance information generation unit 15 proceeds to the processing of step S37. When the estimated quality information Y20 is less than the predetermined quality level (NO in S36), the guidance information generation unit 15 returns to step S34 and repeats the processing of steps S34 and S35.

The processing of steps S34 to S36 will be described using a specific example. For example, it is assumed that the posture information modifying unit 14 generates the modified posture information X20 by adding 1 to the parameter value of the joint position information X21 included in the posture information X30a (S34). The guidance information generation unit 15 inputs the modified posture information X30a to the estimation model 191, and acquires the estimated quality information Y20a as an output (S35).

The guidance information generation unit 15 determines whether the estimated quality information Y20a is a predetermined quality level or higher (S36), and feeds back the determination result to the posture information modifying unit 14. Here, it is assumed that the estimated quality information Y20a is less than the predetermined quality level (NO in S36). The posture information modifying unit 14 further generates modified posture information X30b having a parameter value different from that of the modified posture information X30a according to the feedback (S34). For example, the modified posture information X30b is obtained by subtracting 1 from the parameter value of the joint position information X21 included in the posture information X20. The guidance information generation unit 15 acquires the estimated quality information Y20b from the modified posture information X30b using the estimation model 191 (S35). The guidance information generation unit 15 determines whether the estimated quality information Y20b is a predetermined quality level or higher (S36), and feeds back the determination result to the posture information modifying unit 14.

When the estimated quality information Y20b is the predetermined quality level or higher, the process proceeds to the next step S37, and when the estimated quality information Y20b is less than the predetermined quality level, the posture information modifying unit 14 further generates modified posture information X30c having different parameter values (S34).

As described above, by repeating steps S34 to S36, it is possible to generate the plurality of pieces of modified posture information X30 while appropriately changing the parameter value in the posture information modifying unit 14, and to specify the modified posture information X30 having a predetermined quality level or higher in the guidance information generation unit 15.

In the above-mentioned example, the guidance information generation unit 15 specifies one piece of the modified posture information X30 in which the estimated quality information Y20 has the predetermined quality level or higher, but the present disclosure is not limited thereto. The guidance information generation unit 15 may specify a plurality of pieces of the modified posture information X30 in which the estimated quality information Y20 has a predetermined quality level or higher, and specify the one with the highest quality from among them.

When it is determined in step S36 that the estimated quality information Y20 is the predetermined quality level or higher (YES in S36), the guidance information generation unit 15 generates the guidance information Z10 using the specified modified posture information X30 (S37).

The guidance information generation unit 15 outputs the generated guidance information Z10 to the output unit 18 (S38). For example, the guidance information Z10 may output a message such as “Please stretch your elbows a little more.” by text or voice. The guidance information Z10 may be an image or the like that displays the modified posture information X30 that is a sample of the posture. The user can change the posture by recognizing the guidance information Z10.

Although not illustrated in FIG. 12, the drive control unit 16 may control the driving unit 33 of the biometric information detection apparatus 30 according to the estimated quality information Y20 acquired in step S32 to move the position of the reading unit 31. In this way, for example, even in a case where the user uses a wheelchair or a case where the user is a child or the like who cannot reach the reading unit 31, the reading unit 31 can be moved to a position where the user can easily place his/her hand.

As described above, in the authentication system 1 according to the present example embodiment, the estimation model 191 is learned to estimate the quality information of the biometric information corresponding to the posture information from the input posture information and output the estimated quality information that is the estimation result. As a result, the information processing apparatus 10 can estimate the quality of the biometric information according to the posture of the user.

The posture information may include joint position information, vibration information, body shape information, or the like. Therefore, the information processing apparatus 10 can acquire the estimated quality information using not only the information regarding the posture of the fingers of the user but also the posture of the entire body of the user and other information.

Furthermore, since the information processing apparatus 10 can generate guidance information for prompting the user to change the posture according to the estimated quality information, it is possible to prompt the user to change the posture. For example, in a case where the biometric information detection apparatus reads the fingerprint in a non-contact manner with the user's hand or finger, the user's hand is likely to shake, and it may be difficult to maintain the hand at a correct position. In the present example embodiment, since the quality of the fingerprint can be estimated in consideration of the posture of the entire body of the user, it is possible to guide the user to a reasonable posture even when the biometric information is read in a non-contact manner. As a result, since the information processing apparatus 10 can acquire higher quality biometric information in order to perform biometric authentication, the biometric authentication can be appropriately performed.

Note that the configuration of the authentication system 1 described with reference to FIGS. 3 to 8 is merely an example. The authentication system 1 may be configured using an apparatus or the like in which a plurality of configurations are aggregated. For example, some or all of the functions of the information processing apparatus 10, the posture information detection apparatus 20, the biometric information detection apparatus 30, and the authentication apparatus 50 may be integrated in the same apparatus. Furthermore, for example, each functional unit in each of the information processing apparatus 10, the posture information detection apparatus 20, the biometric information detection apparatus 30, and the authentication apparatus 50 may be subjected to distributed processing using a plurality of apparatuses or the like.

### Third Example Embodiment

Next, a third example embodiment will be described. A third example embodiment is a modified example of the second example embodiment described above. In the present example embodiment, the authentication system 1 in the second example embodiment further includes a quality information calculation unit that calculates quality information Y10 to be teacher data. In the following description, differences from the second example embodiment will be mainly described.

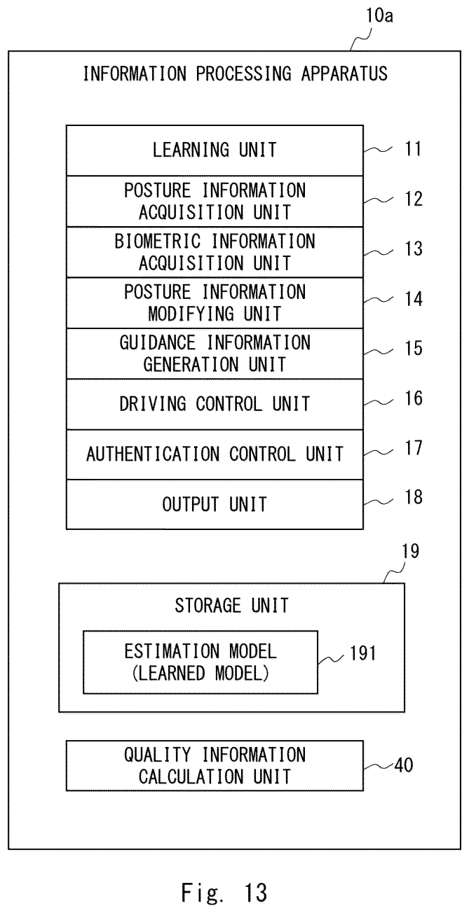

FIG. 13 is a block diagram illustrating a configuration of an information processing apparatus 10a according to the present example embodiment. As illustrated in the figure, the information processing apparatus 10a includes a quality information calculation unit 40 in addition to the configuration of the information processing apparatus 10 described in the second example embodiment. Note that the configuration illustrated in the figure is an example, and the quality information calculation unit 40 may be provided outside the information processing apparatus 10a.

The quality information calculation unit 40 calculates quality information Y10 to be teacher data in the learning unit 11 by using the biometric information corresponding to the posture information of the user.

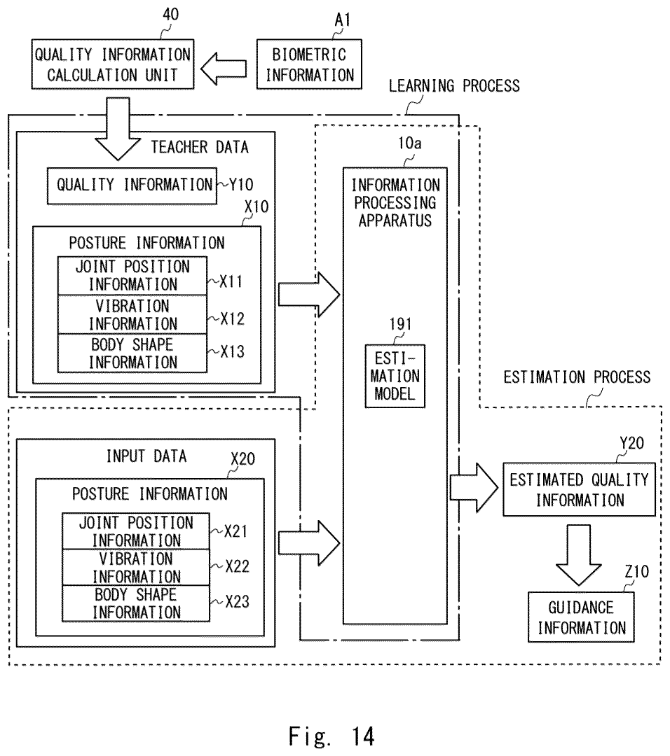

FIG. 14 is a diagram schematically illustrating processing performed by the information processing apparatus 10a according to the present example embodiment. Since components other than the quality information calculation unit 40 and the biometric information A1 illustrated in the upper part of the drawing are similar to those in FIG. 7, redundant description will be omitted. Note that, for the sake of explanation, the quality information calculation unit 40 is illustrated outside the information processing apparatus 10 in the figure.

The quality information calculation unit 40 calculates the quality information of the biometric information A1 acquired by the biometric information acquisition unit 13. The calculation result is used as quality information Y10 which is teacher data.

In the present example embodiment, a fingerprint image obtained by imaging a fingerprint of a user is used as the biometric information A1. Further, as the quality information Y10 indicating the quality of the biometric information A1, a description will be given using the quality value of the fingerprint image. The quality information calculation unit 40 calculates the quality value of the biometric information A1 using a known index or the like, and specifies the quality value as the quality information Y10.

As an index of the quality of a fingerprint image, for example, NIST fingerprint image quality (NIST Fingerprint Image Quality, NFIQ) by the National Institute of Standards and Technology (National Institute of Standards and Technology, NIST) is known. The quality information calculation unit 40 can calculate the quality value of the fingerprint image using NFIQ as an index and specify the calculation result as the quality information Y10.

The present disclosure is not limited thereto, and the quality information calculation unit 40 may calculate a quality value using another index and use the calculation result as the quality information Y10. For example, the quality information calculation unit 40 may receive a result of visually determining the quality of the biometric information A1 by a person and calculate the quality information Y10. For example, the quality information Y10 may be represented by a binary value such as “OK” or “NG,” or may be represented in multiple stages.

Since the above is an example, the quality information calculation unit 40 may calculate the quality information Y10 using another method. For example, the quality value of the fingerprint image may not evaluate the quality of the image itself. Whether or not the user's finger is correctly placed on a guide or the like provided in the reading unit 31 may be evaluated.

Furthermore, the learning unit 11 may cause the estimation model 191 to be relearned using the calculation result in the quality information calculation unit 40. When the quality information calculation unit 40 updates the quality information Y10 serving as the teacher data, the learning unit 11 can cause the estimation model 191 to relearn using the updated quality information Y10. In this way, the estimation accuracy of the estimation model 191 can be further improved even during the operation of the authentication system 1.

### (Processing of Quality Information Calculation Unit 40)

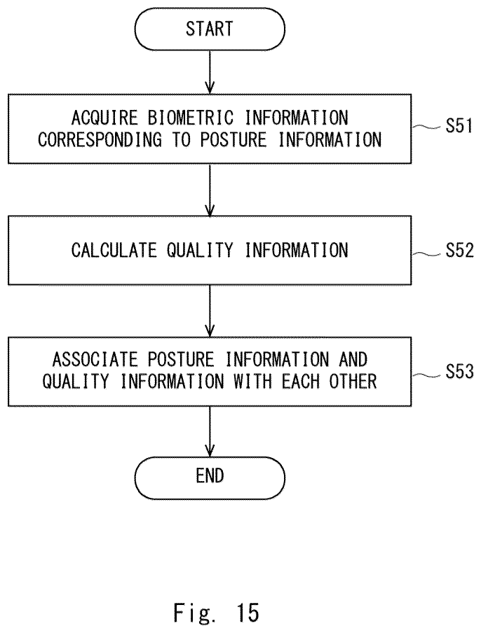

Next, processing performed by the quality information calculation unit 40 will be described with reference to FIG. 15. FIG. 15 is a flowchart illustrating processing performed by the quality information calculation unit 40. First, the quality information calculation unit 40 acquires the biometric information A1 acquired by the biometric information acquisition unit 13 (S51). Here, the biometric information A1 is a fingerprint image of the user read by the biometric information detection apparatus 30. Further, at the time of reading the fingerprint image, the posture information detection apparatus 20 detects posture information of the user.

Next, the quality information calculation unit 40 calculates quality information Y10 indicating the quality of the biometric information A1 (S52). The quality information calculation unit 40 can calculate the quality information Y10 by a predetermined algorithm using the above-described index and the like.

Subsequently, the quality information calculation unit 40 associates posture information X10 of the user when the biometric information A1 is acquired with quality information Y10 which is a calculation result (S53). The quality information calculation unit 40 may update posture information X10 and quality information Y10 which are learning data. As a result, the learning unit 11 can cause the estimation model 191 to relearn using the updated posture information X10 and the updated quality information Y10.

Note that the quality information calculation unit 40 may associate the posture information X10 and the quality information Y10 by performing synchronization using date and time information indicating the date and time when each piece of information is acquired. Alternatively, the quality information calculation unit 40 may perform the above-mentioned association by outputting an instruction signal instructing acquisition timing of each piece of information to the posture information detection apparatus 20 and the biometric information detection apparatus 30.

Configurations other than the quality information calculation unit 40 and the learning unit 11 described above and processing of the information processing apparatus 10a are similar to those in the second example embodiment, and thus detailed description thereof is omitted here.

As described above, the information processing apparatus 10a according to the present example embodiment can achieve effects similar to those of the second example embodiment. In addition, since the quality information calculation unit 40 is provided, the information processing apparatus 10a can efficiently acquire teacher data. Furthermore, since the information processing apparatus 10a can cause the estimation model 191 to relearn using the calculation result in the quality information calculation unit 40, the estimation accuracy can be improved.

### <Hardware Configuration Example>

The functional components of the information processing apparatuses 10 and 10a, the posture information detection apparatus 20, the biometric information detection apparatus 30, and the authentication apparatus 50 described above may be implemented by hardware (for example, a hard-wired electronic circuit or the like) that implements each functional component, or may be implemented by a combination of hardware and software (for example, a combination of an electronic circuit and a program that controls the electronic circuit or the like). Hereinafter, a case where each functional configuration unit such as the information processing apparatus 10 is realized by a combination of hardware and software will be described.

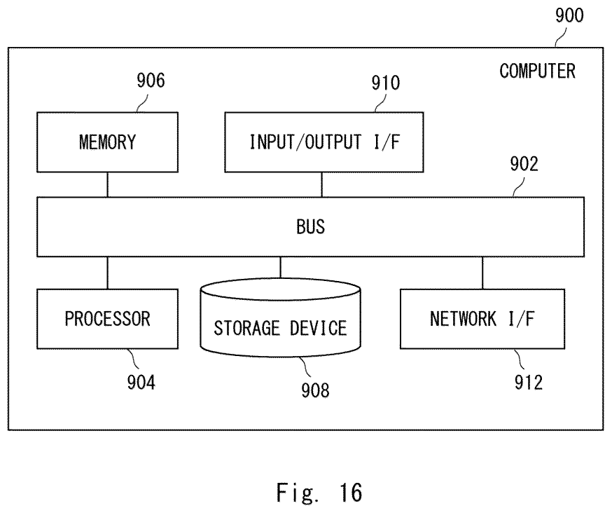

FIG. 16 is a block diagram illustrating a hardware configuration of a computer 900 that implements the information processing apparatus 10 and the like. The computer 900 may be a dedicated computer designed to realize the information processing apparatus 10 and the like, or may be a general-purpose computer. The computer 900 may be a portable computer such as a smartphone and a tablet terminal.

For example, by installing a predetermined application in the computer 900, each function of the information processing apparatus 10 and the like is realized in the computer 900. The application is configured by a program for realizing a functional configuration unit such as the information processing apparatus 10.

The computer 900 includes a bus 902, a processor 904, a memory 906, a storage device 908, an input/output interface 910, and a network interface 912.

The bus 902 is a data transmission path for the processor 904, the memory 906, the storage device 908, the input/output interface 910, and the network interface 912 to transmit and receive data to and from each other. However, a method of connecting the processor 904 and the like to each other is not limited to the bus connection.

The processor 904 is various processors such as a central processing unit (CPU), a graphics processing unit (GPU), a field-programmable gate array (FPGA), and a quantum processor (quantum computer control chip). The memory 906 is a main storage device realized by using a random access memory (RAM) or the like. The storage device 908 is an auxiliary storage device realized by using a hard disk, a solid state drive (SSD), a memory card, a read only memory (ROM), or the like.

The input/output interface 910 is an interface for connecting the computer 900 and an input/output apparatus. For example, an input apparatus such as a keyboard and an output apparatus such as a display apparatus are connected to the input/output interface 910.

The network interface 912 is an interface for connecting the computer 900 to a network. The network may be a local region network (LAN) or a wide region network (WAN).

The storage device 908 stores a program for realizing each functional configuration unit such as the information processing apparatus 10 (a program for realizing the above-described application). The processor 904 reads the program into the memory 906 and executes the program to implement each functional configuration unit such as the information processing apparatus 10.

Each of the processors executes one or more programs including a command group for causing a computer to perform the algorithm described with reference to the drawings. The program includes a command group (or software codes) for causing the computer to perform one or more functions that have been described in the example embodiments in a case where the program is read by the computer. The program may be stored in various types of non-transitory computer-readable media or tangible storage media. As an example and not by way of limitation, non-transitory computer-readable media or tangible storage media include random-access memory (RAM), read-only memory (ROM), flash memory, solid-state drive (SSD) or other memory technology, CD-ROM, digital versatile disc (DVD), Blu-ray (registered trademark) disk or other optical disk storage, magnetic cassettes, magnetic tape, magnetic disk storage, or other magnetic storage devices. The program may be transmitted on various types of transitory computer-readable media or communication media. As an example and not by way of limitation, transitory computer-readable or communication media include electrical, optical, acoustic, or other forms of propagated signals.

Note that the disclosure is not limited to the above-described example embodiments, and can be appropriately modified without departing from the gist. For example, in the above description, the posture information modifying unit 14 generates the modified posture information X30, and the guidance information generation unit 15 generates the guidance information Z10 in response to this, but the present disclosure is not limited thereto. For example, the guidance information generation unit 15 may generate the guidance information Z10 based on the estimated quality information Y20 by referring to a predetermined table.

In the above description, the example in which the estimation model 191 is learned to output the estimated quality information Y20 from the input posture information X20 is used, but the present disclosure is not limited thereto. The estimation model 191 may be learned to estimate the guidance information Z10 from the input posture information X20.

Some or all of the above-described example embodiments may be described as in the following Supplementary Notes, but are not limited to the following Supplementary Notes.

### (Supplementary Note 1)

An information processing apparatus including:
a posture information acquisition unit that acquires posture information indicating a posture of a user who performs biometric authentication;
a learned model learned to estimate the quality information from the input posture information and output the estimated quality information by performing machine learning using the posture information and quality information indicating quality of biometric information corresponding to the posture information as teacher data; and
an output unit that outputs the estimated quality information from the acquired posture information using the learned model.

### (Supplementary Note 2)

The information processing apparatus according to supplementary note 1, in which the posture information includes joint position information indicating a joint position of the user.

(Supplementary Note 3)

The information processing apparatus according to supplementary note 1 or 2, in which the posture information includes vibration information indicating vibration of the user.

### (Supplementary Note 4)

The information processing apparatus according to any one of supplementary notes 1 to 3, in which the posture information includes body shape information indicating a body shape of the user.

(Supplementary Note 5)

The information processing apparatus according to any one of supplementary notes 1 to 4, further including: a guidance information generation unit configured to generate guidance information for prompting a change in the posture of the user according to the estimated quality information.

(Supplementary Note 6)

The information processing apparatus according to supplementary note 5, in which
the posture information includes a parameter value for representing a posture of the user, and
the guidance information generation unit inputs modified posture information having a parameter value different from a parameter value of the posture information to the learned model, and generates the guidance information according to the output estimated quality information.

### (Supplementary Note 7)

The information processing apparatus according to any one of supplementary notes 1 to 6, in which
a biometric information detection apparatus used for the biometric authentication includes a driving unit that moves a reading unit that reads the biometric information of the user, the information processing apparatus further including:
a drive control unit that controls the driving unit in accordance with the estimated quality information.

### (Supplementary Note 8)

The information processing apparatus according to any one of supplementary notes 1 to 7, further including:
a biometric information acquisition unit that acquires the biometric information; and
a quality information calculation unit that calculates the quality information corresponding to the biometric information.

### (Supplementary Note 9)

The information processing apparatus according to supplementary note 8, in which the learned model is relearned using the calculated quality information.

### (Supplementary Note 10)

An authentication system including:
an information processing apparatus; and
an authentication apparatus, in which the information processing apparatus includes:
a posture information acquisition unit that acquires posture information indicating a posture of a user who performs biometric authentication;
a learned model learned to estimate the quality information from the input posture information and output the estimated quality information by performing machine learning using the posture information and quality information indicating quality of biometric information corresponding to the posture information as teacher data; and
an output unit that outputs the estimated quality information from the acquired posture information using the learned model, and the authentication apparatus is configured to:
perform the biometric authentication using the biometric information corresponding to the acquired posture information when the estimated quality information indicates a predetermined quality level or higher.

### (Supplementary Note 11)

The authentication system according to supplementary note 10, in which the posture information includes joint position information indicating a joint position of the user.

### (Supplementary Note 12)

An information processing method for causing a computer to execute:
a posture information acquisition step of acquiring posture information indicating a posture of a user who performs biometric authentication;
a step of inputting the acquired posture information to a learned model learned to estimate the quality information from the input posture information and output estimated quality information by performing machine learning using the posture information and quality information indicating quality of biometric information corresponding to the posture information as teacher data;
a step of receiving the estimated quality information output from the learned model; and
an output step of outputting the received estimated quality information.

### (Supplementary Note 13)

The information processing method according to supplementary note 12, in which the posture information includes joint position information indicating a joint position of the user.

### (Supplementary Note 14)

A program for causing a computer to execute:
a posture information acquisition step of acquiring posture information indicating a posture of a user who performs biometric authentication;
a step of inputting the acquired posture information to a learned model learned to estimate the quality information from the input posture information and output estimated quality information by performing machine learning using the posture information and quality information indicating quality of biometric information corresponding to the posture information as teacher data;
a step of receiving the estimated quality information output from the learned model; and
an output step of outputting the received estimated quality information.

### (Supplementary Note 15)

The program according to supplementary note 14, in which the posture information includes joint position information indicating a joint position of the user.

### (Supplementary Note 16)

A learned model including:
an input layer that receives input of posture information indicating a posture of a user who performs biometric authentication; and
an output layer that estimates quality information indicating quality of biometric information corresponding to the posture information and outputs estimated quality information,
the learned model causing a computer to function to:
input the posture information to the input layer and output the estimated quality information from the output layer.

### (Supplementary Note 17)

The learned model according to supplementary note 16, in which the posture information includes joint position information indicating a joint position of the user.

### (Supplementary Note 18)

A method for generating a learned model causing a computer to execute:
an acquisition step of acquiring teacher data in which posture information indicating a posture of a user who performs biometric authentication is associated with a correct value of quality information indicating quality of biometric information corresponding to the posture information; and
a generation step of generating a learned model that estimates the quality information and outputs the estimated quality information when the posture information is input based on the acquired teacher data.

### (Supplementary Note 19)

The method for generating a learned model according to supplementary note 18, in which the posture information includes joint position information indicating a joint position of the user.

Although the invention of the present application has been described above with reference to the example embodiments, the invention of the present application is not limited to the above. Various modifications that can be understood by those skilled in the art can be made to the configuration and details of the invention of the present application within the scope of the invention.

This application claims priority based on Japanese Patent Application No. 2022-086397 filed on May 26, 2022, the entire disclosure of which is incorporated herein.

### REFERENCE SIGNS LIST

1 AUTHENTICATION SYSTEM
10, 10a INFORMATION PROCESSING APPARATUS
11 LEARNING UNIT
12 POSTURE INFORMATION ACQUISITION UNIT
13 BIOMETRIC INFORMATION ACQUISITION UNIT
14 POSTURE INFORMATION MODIFYING UNIT
15 GUIDANCE INFORMATION GENERATION UNIT
16 DRIVE CONTROL UNIT
17 AUTHENTICATION CONTROL UNIT
18 OUTPUT UNIT
19 STORAGE UNIT
191 ESTIMATION MODEL
20 POSTURE INFORMATION DETECTION APPARATUS
21 IMAGING UNIT
22 ANALYSIS UNIT
30 BIOMETRIC INFORMATION DETECTION APPARATUS
31 READING UNIT
32 DETECTION UNIT
33 DRIVING UNIT
40 QUALITY INFORMATION CALCULATION UNIT
50 AUTHENTICATION APPARATUS
51 AUTHENTICATION STORAGE UNIT
52 FEATURE IMAGE EXTRACTION UNIT
53 FEATURE POINT EXTRACTION UNIT
54 REGISTRATION UNIT
55 AUTHENTICATION UNIT
100 INFORMATION PROCESSING APPARATUS
101 POSTURE INFORMATION ACQUISITION UNIT
102 LEARNED MODEL
103 OUTPUT UNIT
900 COMPUTER
902 BUS
904 PROCESSOR
906 MEMORY
908 STORAGE DEVICE
910 INPUT/OUTPUT INTERFACE
912 NETWORK INTERFACE
A1 BIOMETRIC INFORMATION
L1 INPUT LAYER
L2 INTERMEDIATE LAYER
L3 OUTPUT LAYER
N NETWORK
X10, X20 POSTURE INFORMATION
X11, X21 JOINT POSITION INFORMATION
X12, X22 VIBRATION INFORMATION
X13, X23 BODY SHAPE INFORMATION
X30 MODIFIED POSTURE INFORMATION
Y10 QUALITY INFORMATION
Y20 ESTIMATED QUALITY INFORMATION
Z10 GUIDANCE INFORMATION

What is claimed is:

1. An information processing apparatus comprising:
at least one memory storing instructions; and
at least one processor configured to execute the instructions to:
acquire posture information indicating a posture of a user who performs biometric authentication;
input the acquired posture information to a learned model learned to estimate quality information from the input posture information and output estimated quality information by performing machine learning using the posture information and quality information indicating quality of biometric information corresponding to the posture information as teacher data;
receive the estimated quality information output from the learned model; and
output the received estimated quality information.

2. The information processing apparatus according to claim 1, wherein the posture information includes joint position information indicating a joint position of the user.

3. The information processing apparatus according to claim 1, wherein the posture information includes vibration information indicating vibration of the user.

4. The information processing apparatus according to claim 1, wherein the posture information includes body shape information indicating a body shape of the user.

5. The information processing apparatus according to claim 1, wherein the at least one processor is further configured to execute the instructions to generate guidance information for prompting a change in the posture of the user according to the estimated quality information.

6. The information processing apparatus according to claim 5, wherein
the posture information includes a parameter value for representing a posture of the user, and the at least one processor is further configured to execute the instructions to
input modified posture information having a parameter value different from a parameter value of the posture information to the learned model, and generate the guidance information according to the output estimated quality information.

7. The information processing apparatus according to claim 1, wherein a biometric information detection apparatus used for the biometric authentication includes driving means for moving reading means for reading the biometric information of the user, the at least one processor is further configured to execute the instructions to
control the driving means in accordance with the estimated quality information.

8. The information processing apparatus according to claim 1, wherein the at least one processor is further configured to execute the instructions to:
acquire the biometric information; and
calculate the quality information corresponding to the biometric information.

9. The information processing apparatus according to claim 8, wherein the learned model is relearned using the calculated quality information.

10-11. (canceled)

12. An information processing method for causing a computer to execute:
acquiring posture information indicating a posture of a user who performs biometric authentication;
inputting the acquired posture information to a learned model learned to estimate quality information from the input posture information and output estimated quality information by performing machine learning using the posture information and quality information indicating quality of biometric information corresponding to the posture information as teacher data;
receiving the estimated quality information output from the learned model; and
outputting the received estimated quality information.

13. The information processing method according to claim 12, wherein the posture information includes joint position information indicating a joint position of the user.

14. A non-transitory computer-readable medium having a program stored thereon, the program causing a computer to execute:
acquiring posture information indicating a posture of a user who performs biometric authentication;
inputting the acquired posture information to a learned model learned to estimate quality information from the input posture information and output estimated quality information by performing machine learning using the posture information and quality information indicating quality of biometric information corresponding to the posture information as teacher data;
receiving the estimated quality information output from the learned model; and
outputting the received estimated quality information.

15. The non-transitory computer-readable medium according to claim 14, wherein the posture information includes joint position information indicating a joint position of the user.

16-19. (canceled)
